(19) United States
(12) Patent Application Publication
(10) Pub. No.: US 2024/0329564 A1
(43) Pub. Date: Oct. 3, 2024

(54) DEVELOPING DEVICE AND IMAGE FORMING APPARATUS

(71) Applicant: FUJIFILM BUSINESS INNOVATION CORP., Tokyo (JP)

(72) Inventors: Mitsutoshi HONGO, Kanagawa (JP); Atsushi FUNADA, Kanagawa (JP); Tatsuya TAMAI, Kanagawa (JP); Mizue SEKINE, Kanagawa (JP)

(73) Assignee: FUJIFILM BUSINESS INNOVATION CORP., Tokyo (JP)

(21) Appl. No.: 18/365,003

(22) Filed: Aug. 3, 2023

(30) Foreign Application Priority Data
Mar. 29, 2023 (JP) 2023-053710

(51) Int. Cl. G03G 15/08

(52) U.S. Cl. CPC G03G 15/0891

(57) ABSTRACT

A developing device includes a tubular member through which developer is to be transported, an end support that supports an end of the tubular member, and a blocking member that extends over an end face of the tubular member and the end support and that blocks the developer from entering a gap between an outer peripheral surface of the tubular member and the end support.

### CROSS-REFERENCE TO RELATED APPLICATIONS

This application is based on and claims priority under 35 USC 119 from Japanese Patent Application No. 2023-053710 filed Mar. 29, 2023.

### BACKGROUND

### (i) Technical Field

The present disclosure relates to a developing device and an image forming apparatus.

### (ii) Related Art

A container device disclosed by Japanese Unexamined Patent Application Publication No. 2018-155873 includes a container that contains developer; a transporting member including a shaft and a transporting portion, the shaft being rotatably supported by the container, the transporting portion being supported by the shaft and configured to transport the developer in the container when the shaft rotates; and a pathway provided in the transporting member and through which air is allowed to pass in the axial direction of the shaft.

### SUMMARY

Some of developing devices configured to perform development on an image carrier have thereinside a path along which developer moves.

If any path along which developer moves is provided not as a part of a housing but as a tubular member provided separately from the housing or any other member, a problem tends to occur that, for example, some developer may enter the gap between the tubular member and a support that supports the tubular member.

Aspects of non-limiting embodiments of the present disclosure relate to a configuration in which developer is less likely to enter the gap between a tubular member through which the developer passes and a support that supports the tubular member than in a configuration in which no mechanism is provided for blocking the developer from entering the gap between the tubular member through which the developer passes and the support that supports the tubular member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device including a tubular member through which developer is to be transported, an end support that supports an end of the tubular member, and a blocking member that extends over an end face of the tubular member and the end support and that blocks the developer from entering a gap between an outer peripheral surface of the tubular member and the end support.

### BRIEF DESCRIPTION OF THE DRAWINGS

An exemplary embodiment of the present disclosure will be described in detail based on the following figures, wherein:

FIG. 1 illustrates an image forming apparatus;

FIG. 2 is a top view of a developing device;

FIG. 3 is a sectional view of the developing device, taken along line III-III given in FIG. 2;

FIG. 4 is a sectional view of the developing device, taken along line IV-IV given in FIG. 2;

FIG. 5 is a sectional view of the developing device, taken along line V-V given in FIG. 2;

FIG. 6 is a perspective view of a section of the developing device that is taken along line VI-VI given in FIG. 2;

FIG. 7 is an upper perspective view of the developing device;

FIG. 8 is a sectional view of the developing device, taken along line VIII-VIII given in FIG. 7;

FIG. 9 is a sectional view of the developing device, taken along line IX-IX given in FIG. 8;

FIG. 10 is a perspective view of a pipe;

FIG. 11 is a perspective view of a pipe supporting member;

FIG. 12 is an enlargement of a part at a first end of the pipe supporting member;

FIG. 13 is a sectional view taken along line XIII-XIII given in FIG. 12; and

FIG. 14 is a perspective view of a section of a lower part of the developing device that is taken in a longitudinally central part of the developing device.

### DETAILED DESCRIPTION

An exemplary embodiment of the present disclosure will now be described with reference to the accompanying drawings.

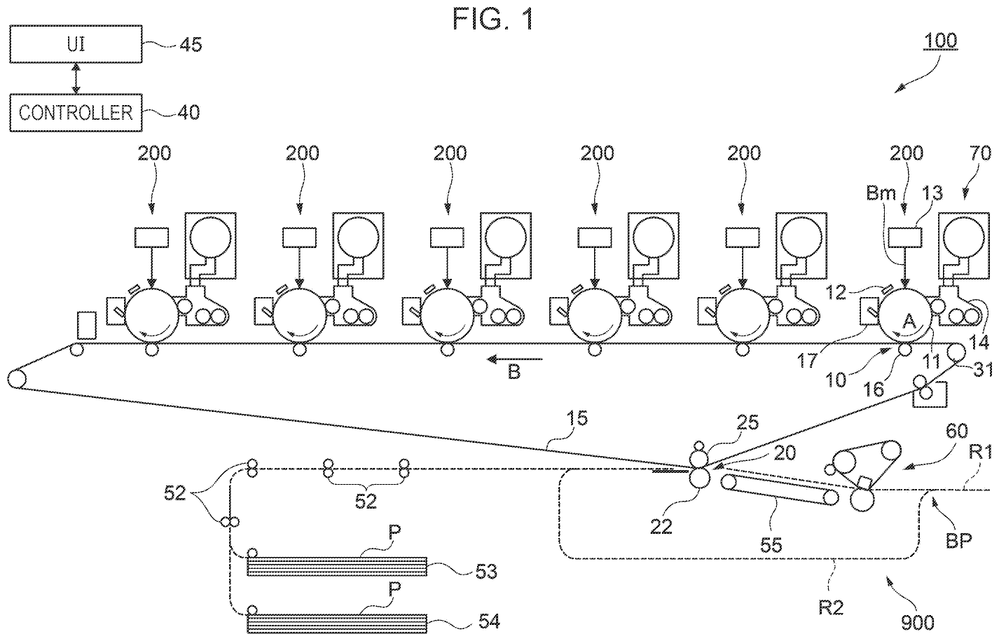

FIG. 1 illustrates an image forming apparatus 100 according to the present exemplary embodiment. The image forming apparatus 100 illustrated in FIG. 1 is viewed from the front side.

The image forming apparatus 100 is of a so-called tandem type and employs an intermediate transfer scheme.

The image forming apparatus 100 includes a plurality of image forming units 200, which are configured to form an image to be transferred to a sheet P. an exemplary recording medium.

Each image forming unit 200 includes a photoconductor drum 11, which is an exemplary image carrier and on which a toner image to be transferred to a sheet P is formed by using a developer containing a toner. In other words, the image forming unit 200 is configured to form a toner image to be transferred to a sheet P on the photoconductor drum 11 by using developer particles.

The developer according to the present exemplary embodiment is composed of a dry carrier and a dry toner. The image forming unit 200 forms a toner image on the photoconductor drum 11 by using the carrier and the toner.

The plurality of image forming units 200, six in total, form respective toner images on the respective photoconductor drums 11 by using respective developers that are of different kinds.

In the present exemplary embodiment, four of the six image forming units 200 form toner images from developers having basic colors of yellow, magenta, cyan, and black.

The remaining two image forming units 200 form toner images from developers having nonbasic colors, such as a clear color, white, gold, silver, pink, green, orange, and the like.

The developers having nonbasic colors may each alternatively be a developer containing a magnetic toner, or a developer containing an electrically conductive toner. Furthermore, a developer containing a toner that emits light by receiving light such as ultraviolet light or infrared light may also be employed as a developer having a nonbasic color.

While the present exemplary embodiment employs a so-called two-component developer that is a mixture of a carrier and a toner, the developer is not limited thereto and may be a so-called single-component developer composed of a toner alone.

The image forming apparatus 100 further includes an intermediate transfer belt 15 and first-transfer units 10. In the first-transfer unit 10, the toner images formed by the respective image forming units 200 are to be transferred to the intermediate transfer belt 15.

The image forming apparatus 100 further includes a second-transfer unit 20, in which the toner images transferred to the intermediate transfer belt 15 are to be transferred to a sheet P.

The image forming apparatus 100 further includes a fixing device 60, in which the toner images transferred to the sheet P are fixed thereon.

The image forming apparatus 100 further includes a controller 40, which includes a central processing unit (CPU) configured to execute programs to control relevant elements included in the image forming apparatus 100.

The image forming apparatus 100 further includes a user interface (UI) 45, which includes a display panel or the like and is configured to receive instructions from the user and to provide relevant information to the user.

The image forming units 200 include respective developing devices 14. The image forming units 200 further include respective developer refilling devices 70, which are configured to refill the respective developing devices 14 with the respective developers.

The developing devices 14 are configured to visualize, by using the respective toners, electrostatic latent images that are formed on the respective photoconductor drums 11. In other words, the developing devices 14 perform development on the respective photoconductor drums 11 serving as image carriers, and thus form images composed of the respective toners on the photoconductor drums 11.

The developer refilling devices 70 are configured to refill the developing devices 14 with the developers. As described above, the developers are each composed of a carrier and a toner, and the developer refilling devices 70 each refill the corresponding developing device 14 with the carrier and the toner that compose the corresponding developer. In the present exemplary embodiment, the carrier has positive charging polarity, whereas the toner has a negative charge polarity.

In each image forming unit 200, the photoconductor drum 11 serving as an exemplary image carrier rotates in the direction of arrow A.

Each image forming unit 200 further includes a charging device 12, which is configured to charge the photoconductor drum 11; and a laser exposure device 13, which is an exemplary exposure device and is configured to form an electrostatic latent image on the photoconductor drum 11. Referring to FIG. 1, the laser exposure device 13 emits an exposure beam Bm. As an alternative exposure device, a device including another light source such as a light-emitting diode (LED) may be employed.

In correspondence with the image forming units 200, first-transfer rolls 16 are provided to transfer the toner images formed on the photoconductor drums 11 to the intermediate transfer belt 15 in the respective first-transfer units 10. Each image forming unit 200 further includes a drum cleaner 17, which is configured to remove developer particles remaining on the photoconductor drum 11.

The intermediate transfer belt 15 is to be rotated at a predetermined speed in the direction of arrow B given in FIG. 1 by a driving roll 31, which is to be driven by a motor (not illustrated).

The first-transfer rolls 16 included in the first-transfer units 10 are located across the intermediate transfer belt 15 from the respective photoconductor drums 11. The toner images formed on the respective photoconductor drums 11 are sequentially attracted to the intermediate transfer belt 15 with an electrostatic force, thereby being superposed one on top of another to form an integrated toner image (hereinafter also simply referred to as “toner image”) on the intermediate transfer belt 15.

The second-transfer unit 20 is an exemplary transfer unit and includes a second-transfer roll 22, which is positioned facing the outer surface of the intermediate transfer belt 15; and a backup roll 25, which is positioned facing the inner surface of the intermediate transfer belt 15.

In the present exemplary embodiment, the integrated toner image composed of the toner images formed by the image forming units 200 and transferred to the intermediate transfer belt 15 is transferred by the second-transfer unit 20 to a sheet P transported to the second-transfer unit 20.

In the present exemplary embodiment, a reversing mechanism 900 is provided to reverse the sheet P.

The reversing mechanism 900 turns over the sheet P having the toner image transferred to one side thereof in the second-transfer unit 20, and supplies the sheet P to the second-transfer unit 20 again.

Hence, in the present exemplary embodiment, the formation of a toner image is performable on both sides of the sheet P.

Specifically, the reversing mechanism 900 according to the present exemplary embodiment includes a branch path R2, which branches off from a sheet transport path R1 and into which the sheet P exited from the fixing device 60 and is to be turned over is sent. More specifically, in the reversing mechanism 900, after the sheet P passes through a branch point BP, the sheet P is transported backward and is sent into the branch path R2.

The branch path R2 meets the sheet transport path R1 at a position upstream of the second-transfer unit 20. Therefore, in the present exemplary embodiment, the sheet P that has been turned over is supplied to the second-transfer unit 20 again. In such a case, the formation of a toner image is performed not only on one side of the sheet P but also on the other side of the sheet P; that is, toner images are formed on both sides of the sheet P.

The entire flow of operations performed by the image forming apparatus 100 is as follows.

The image forming apparatus 100 receives image data from, for example, an image reading device or a computer (not illustrated). The received image data is processed. Thus, pieces of image data for the respective image forming units 200 are generated.

For example, the following pieces of image data are generated: pieces of image data to be used in forming images from the developers having the basic colors of yellow, magenta, cyan, and black; and pieces of image data to be used in forming images from the developers having nonbasic colors. The pieces of image data thus generated are outputted to the respective laser exposure devices 13 included in the respective image forming units 200.

In accordance with the pieces of image data received, the laser exposure devices 13 apply to the photoconductor drums 11 respective exposure beams Bm emitted from, for example, respective semiconductor lasers.

In the present exemplary embodiment, the charging devices 12 charge the surfaces of the respective photoconductor drums 11, and then the laser exposure devices 13 perform scan exposure on the respective charged surfaces. Thus, electrostatic latent images are formed on the surfaces of the respective photoconductor drums 11.

Subsequently, the developing devices 14 perform development, whereby toner images are formed on the respective photoconductor drums 11. The toner images are then transferred to the intermediate transfer belt 15 by the respective first-transfer units 10 to be integrated.

With the rotation of the intermediate transfer belt 15, the integrated toner image on the intermediate transfer belt 15 moves to the second-transfer unit 20. Meanwhile, transporting rolls 52 and other relevant elements transport a sheet P from a first sheet container 53 or a second sheet container 54 to the second-transfer unit 20.

Then, the toner image on the intermediate transfer belt 15 is electrostatically transferred to the sheet P in the second-transfer unit 20.

The sheet P thus having the toner image transferred thereto is released from the intermediate transfer belt 15 and is received by a transporting belt 55. The transporting belt 55 transports the sheet P to the fixing device 60.

The sheet P received by the fixing device 60 is heated and pressed by the fixing device 60. Thus, the toner image is fixed on the sheet P. Eventually, the sheet P is discharged from the image forming apparatus 100.

If another toner image is to be formed on the other side of the sheet P, the sheet P exited from the fixing device 60 is sent into the branch path R2 and is supplied to the second-transfer unit 20 again.

In the second-transfer unit 20, another toner image is transferred to the other side of the sheet P. Then, the sheet P passes through the fixing device 60 again, whereby the toner image transferred to the other side of the sheet P is also fixed.

The developing device 14 will now be described.

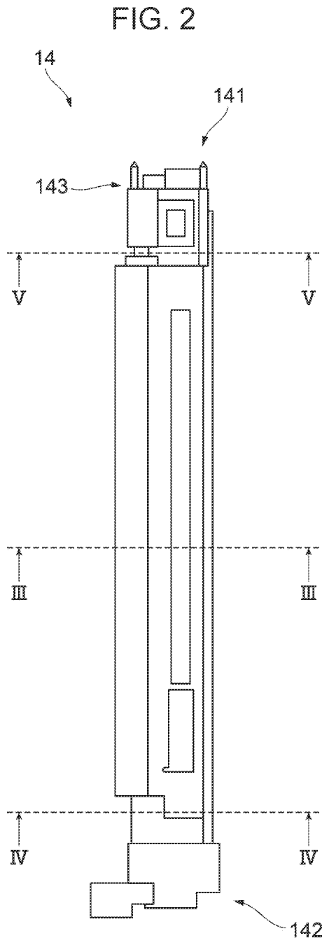

FIG. 2 is a top view of the developing device 14.

The developing device 14 is set in the image forming apparatus 100 in such a manner as to extend in the depthwise direction of the image forming apparatus 100. The developing device 14 has a first end 141 and a second end 142, which are at different positions in the longitudinal direction.

When the developing device 14 is set in the image forming apparatus 100, the first end 141 is positioned on the rear side of the image forming apparatus 100, whereas the second end 142 is positioned on the front side of the image forming apparatus 100.

The developing device 14 includes at the first end 141 thereof a driving-force receiver 143, which is configured to receive a driving force.

In the present exemplary embodiment, the driving-force receiver 143 receives a driving force transmitted from a drive source (not illustrated), such as a motor, provided in the body of the image forming apparatus 100.

The driving-force receiver 143 is linked to transporting members and other relevant elements (to be described below) included in the developing device 14. In the present exemplary embodiment, when the driving force of the drive source is transmitted to the driving-force receiver 143, the transporting members and other relevant elements rotate.

In the present exemplary embodiment, the members that rotate by receiving the driving force from the drive source are the following four members: a first-direction transporting member, a second-direction transporting member, a counter member, and a lower transporting member, as to be described below. The driving-force receiver 143 may be provided for each of the four members. In that case, the four driving-force receivers 143 may individually receive the driving force from the drive sources.

Such driving-force receivers 143 to be provided may be fewer than the above four members; that is, a configuration with a single driving-force receiver 143 is also acceptable. Furthermore, the developing device 14 may include a transmitting mechanism (not illustrated) through which the driving force of the drive source that is received by the driving-force receiver 143 is transmitted to the four members.

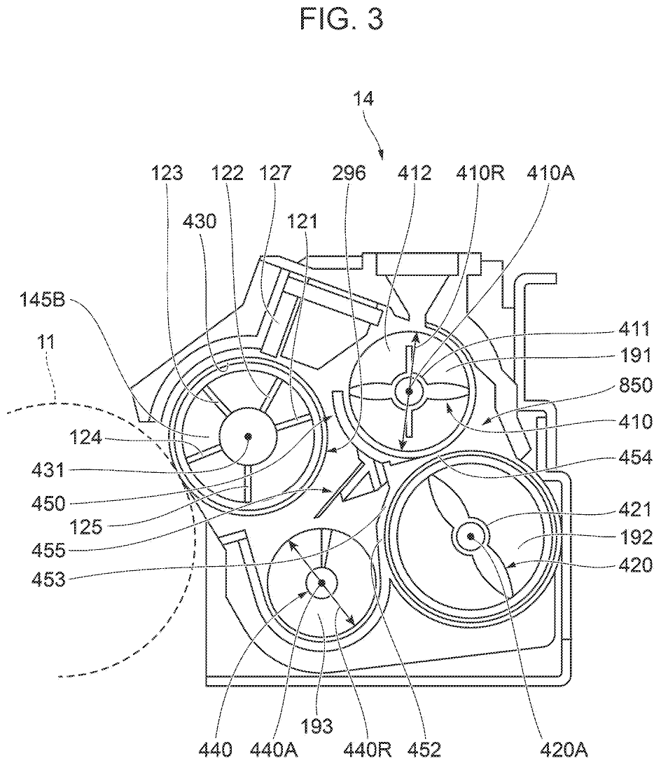

FIG. 3 is a sectional view of the developing device 14, taken along line III-III given in FIG. 2. The section illustrated in FIG. 3 is taken in a longitudinally central part of the developing device 14.

In the developing device 14, a first-direction movement path 191 is provided for the developer to move in a first direction.

Furthermore, in the developing device 14, a second-direction movement path 192 is provided for the developer to move in a second direction, which is opposite to the first direction. The second-direction movement path 192 is located lower than the first-direction movement path 191.

In the first-direction movement path 191, the developer moves toward the far side in a direction perpendicular to the plane of the page in FIG. 3. In the second-direction movement path 192, the developer moves toward the near side in the direction perpendicular to the plane of the page in FIG. 3.

The first-direction movement path 191 is provided with a first-direction transporting member 410, which is configured to transport the developer. In the present exemplary embodiment, when the first-direction transporting member 410 rotates about a rotation shaft 411, extending along the first-direction movement path 191, the developer moves toward the far side.

Specifically, in the present exemplary embodiment, when the first-direction transporting member 410 rotates by receiving the driving force transmitted thereto through the driving-force receiver 143 (see FIG. 2) described above, the developer moves toward the far side.

In the present exemplary embodiment, the first-direction transporting member 410 transports the developer in the direction toward the far side, which is regarded as the first direction. The first-direction transporting member 410 is a rotatable member that is rotatable about an axial center 410A, which extends in the first direction.

The second-direction movement path 192 is provided with a second-direction transporting member 420, which is configured to transport the developer. The second-direction transporting member 420 is located lower than the first-direction transporting member 410.

In the present exemplary embodiment, when the second-direction transporting member 420 rotates about a rotation shaft 421, extending along the second-direction movement path 192, the developer moves toward the near side.

Specifically, when the second-direction transporting member 420 rotates by receiving the driving force transmitted thereto through the driving-force receiver 143 described above, the developer moves toward the near side.

In the present exemplary embodiment, the second-direction transporting member 420 transports the developer in the second direction that is opposite to the first direction described above.

At a position to the left of the first-direction transporting member 410, a counter member 430 is provided facing the photoconductor drum 11 serving as an exemplary image carrier.

The counter member 430 is configured to supply the photoconductor drum 11 with the developer that is supplied from the first-direction transporting member 410. In other words, the counter member 430 receives the developer from the first-direction transporting member 410 and supplies the received developer to the photoconductor drum 11.

The counter member 430 is a circular cylindrical member. The counter member 430 is made of, for example, metal such as stainless used steel (SUS).

When the counter member 430 receives the driving force transmit thereto through the driving-force receiver 143, the counter member 430 rotates about an axial center 431 counterclockwise in FIG. 3, thereby moving the developer received from the first-direction transporting member 410 and adhered to the outer peripheral surface of the counter member 430 to the photoconductor drum 11.

Thus, the developer is supplied to the photoconductor drum 11, and the toner contained in the developer adheres to the surface of the photoconductor drum 11.

In the present exemplary embodiment, the counter member 430 and the first-direction transporting member 410 are positioned such that the axial center 410A of the first-direction transporting member 410 is located higher than the axial center 431 of the counter member 430.

The counter member 430 is a rotatable member that is rotatable about the axial center 431, which extends in the first direction described above. The first-direction transporting member 410 is also a rotatable member that is rotatable about the axial center 410A extending in the first direction described above.

In the present exemplary embodiment, the counter member 430 and the first-direction transporting member 410 are positioned such that the axial center 410A of the first-direction transporting member 410 is located higher than the axial center 431 of the counter member 430.

In the present exemplary embodiment, a first movement stopper 450 is provided between the counter member 430 and the first-direction transporting member 410 and stops the movement of some of the developer coming from the first-direction transporting member 410 toward the counter member 430.

In the present exemplary embodiment, some of the developer in the first-direction movement path 191 that goes over the first movement stopper 450 is supplied to the counter member 430.

In the present exemplary embodiment, a lower transporting member 440 is provided at a position lower than the counter member 430. The lower transporting member 440 is a rotatable member that is rotatable about an axial center 440A, which extends in the first direction described above.

The lower transporting member 440 is located closer to the photoconductor drum 11 than the second-direction transporting member 420.

The lower transporting member 440 and the second-direction transporting member 420 both extend in the first direction described above but are displaced from each other in the horizontal direction.

The lower transporting member 440 is configured to transport the developer, released from the counter member 430, toward the far side in the direction perpendicular to the plane of the page in FIG. 3.

Specifically, the lower transporting member 440 is configured to receive the developer released from the counter member 430 and transport the developer in the first direction described above to supply the developer to a first end of the second-direction transporting member 420 (details will be described separately below).

When the lower transporting member 440 receives the driving force transmitted thereto through the driving-force receiver 143, the lower transporting member 430 rotates, thereby transporting the developer released from the counter member 430 toward the far side in the direction perpendicular to the plane of the page in FIG. 3.

The lower transporting member 440 is provided in a lower movement path 193, which is located closer to the photoconductor drum 11 than the second-direction movement path 192.

The lower movement path 193 extends in the direction perpendicular to the plane of the page in FIG. 3 and is located below the counter member 430. In the present exemplary embodiment, the developer released from the counter member 430 moves along the lower movement path 193.

In the present exemplary embodiment, a second movement stopper 452 is provided between the lower transporting member 440 and the second-direction transporting member 420 and stops the movement of the developer from the second-direction transporting member 420 toward the lower transporting member 440.

In the present exemplary embodiment, a third movement stopper 453 is provided between the counter member 430 and the second-direction transporting member 420 and stops the movement of the developer from the second-direction transporting member 420 toward the counter member 430.

In the present exemplary embodiment, a fourth movement stopper 454 is provided between the first-direction transporting member 410 and the second-direction transporting member 420 and stops the movement of the developer from the first-direction transporting member 410 toward the second-direction transporting member 420 and from the second-direction transporting member 420 toward the first-direction transporting member 410.

In the present exemplary embodiment, the second to fourth movement stoppers 452 to 454 are integrated altogether. That is, the second to fourth movement stoppers 452 to 454 as a whole form a single component.

In the present exemplary embodiment, a fifth movement stopper 455 is provided between the counter member 430 and the lower transporting member 440 and stops the movement of the developer from the lower transporting member 440 toward the counter member 430.

In the present exemplary embodiment, a magnetic roll 145B is provided inside the counter member 430.

The magnetic roll 145B includes five magnetic poles 121 to 125, which are arranged side by side in the peripheral direction of the magnetic roll 145B.

The magnetic pole 121 serves as a pick-up pole and attracts the developer supplied from the first-direction movement path 191. Thus, the developer adheres to the surface of the counter member 430.

The magnetic poles 122 to 124 serve as transporting poles and transport the developer on the surface of the counter member 430 toward the downstream side in the direction of rotation of the counter member 430.

At a position downstream of the magnetic pole 122 but upstream of the magnetic pole 123 in the direction of rotation of the counter member 430, a counter regulator 127 is provided facing the outer peripheral surface of the counter member 430.

The counter regulator 127 faces the counter member 430 with a gap in between.

The counter regulator 127 stops the movement of some of the developer adhered to the surface of the counter member 430, thereby regulating the thickness of the developer on the surface of the counter member 430 to a predetermined thickness.

In other words, the counter regulator 127 stops the movement of some of the developer adhered to the outer peripheral surface of the counter member 430 and moving toward the photoconductor drum 11 with the rotation of the counter member 430.

While the developer on the surface of the counter member 430 is moving toward the downstream side in the direction of rotation of the counter member 430, the developer moves to the surface of the photoconductor drum 11 serving as an exemplary image carrier, whereby the toner contained in the developer adheres to the photoconductor drum 11.

This is how development is performed, in which an image composed of the toner is formed on the surface of the photoconductor drum 11.

The image thus obtained is temporarily carried by the photoconductor drum 11 until the image reaches the first-transfer unit 10 (see FIG. 1) with the rotation of the photoconductor drum 11. Then, the image is transferred to the intermediate transfer belt 14.

The magnetic pole 125 (see FIG. 3) serves as a pick-off pole and generates a repelling magnetic field with which the developer on the surface of the counter member 430 is released from the counter member 430. The magnetic pole 125 causes some developer having failed to be transferred to the photoconductor drum 11 and remaining on the surface of the counter member 430 to be released from the counter member 430.

The developer thus released from the counter member 430 drops into the lower movement path 193.

The developer thus reached the lower movement path 193 is transported by the lower transporting member 440 toward the first end 141 (see FIG. 2) of the developer 14, and then moves into the second-direction movement path 192 (see FIG. 3) (details will be described separately below).

The first-direction transporting member 410 (see FIG. 3), the second-direction transporting member 420, the counter member 430, the magnetic roll 145B, and the lower transporting member 440 each extend in the direction perpendicular to the plane of the page in FIG. 3 and are parallel to one another.

The first-direction transporting member 410 includes the rotation shaft 411 extending in the longitudinal direction of the developing device 14; and a projecting member 412, which projects from the outer peripheral surface of the rotation shaft 411.

The projecting member 412 spirally extends from one axial end to the other axial end of the rotation shaft 411. In other words, the projecting member 412 is in the form of a screw.

In the present exemplary embodiment, when the rotation shaft 411 of the first-direction transporting member 410 rotates, the projecting member 412 pushes the developer in the axial direction of the rotation shaft 411, whereby the developer moves in the direction in which the rotation shaft 411 extends.

The second-direction transporting member 420 and the lower transporting member 440 have the same configuration as the first-direction transporting member 410 and include respective rotation shafts extending in the longitudinal direction of the developing device 14 and respective spiral projecting members.

The first-direction transporting member 410, the second-direction transporting member 420, the counter member 430, and the lower transporting member 440 are rotatable members that are rotatable about the respective axial centers extending in the first direction described above.

In the present exemplary embodiment, in terms of the position in the horizontal direction, the axial center, 420A, of the second-direction transporting member 420 is located farther from the counter member 430 than the axial center 410A of the first-direction transporting member 410.

In the present exemplary embodiment, as viewed vertically, the axial center 420A of the second-direction transporting member 420 is displaced from the axial center 410A of the first-direction transporting member 410.

In the present exemplary embodiment, as viewed vertically, the axial center 440A of the lower transporting member 440 is displaced from the axial center 431 of the counter member 430.

More specifically, in the present exemplary embodiment, in terms of the position in the horizontal direction, the axial center 440A of the lower transporting member 440 is located closer to the second-direction transporting member 420 than the axial center 431 of the counter member 430.

Furthermore, in the present exemplary embodiment, in terms of the position in the vertical direction, the axial center 440A of the lower transporting member 440 is located lower than the axial center 420A of the second-direction transporting member 420.

In the present exemplary embodiment, the outside diameter, 440R, of the lower transporting member 440 is smaller than the outside diameter, 410R, of the first-direction transporting member 410. Furthermore, in the present exemplary embodiment, the number of revolutions of the lower transporting member 440 is greater than or equal to the number of revolutions of the first-direction transporting member 410.

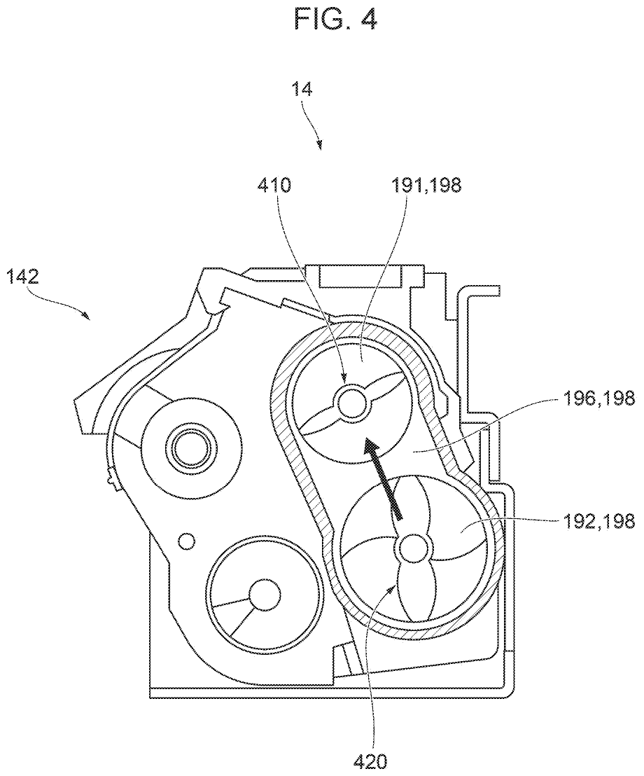

FIG. 4 is a sectional view of the developing device 14, taken along line IV-IV given in FIG. 2.

The section illustrated in FIG. 4 is taken at the second end 142 of the developing device 14.

In the present exemplary embodiment, as illustrated in FIG. 4, an upward movement path 196 is provided at the second end 142 of the developing device 14 and extends in the top-bottom direction.

In the present exemplary embodiment, the developer transported along the second-direction movement path 192 passes through the upward movement path 196 toward the first-direction movement path 191.

Herein, the expression “to extend in the top-bottom direction” is not limited to a situation where the upward movement path 196 extends in the vertical direction and encompasses a situation where the upward movement path 196 is inclined relative to the vertical direction.

In the present exemplary embodiment, the developer transported by the second-direction transporting member 420 and reached the second end 142 of the developing device 14 builds up in a lower part of the upward movement path 196, thereby gradually moving upward in the upward movement path 196.

Thus, the developer is supplied to the first-direction transporting member 410. The first-direction transporting member 410 receives the developer coming from the upward movement path 196 and transports the developer along the first-direction movement path 191 toward the first end 141 (see FIG. 2) of the developing device 14.

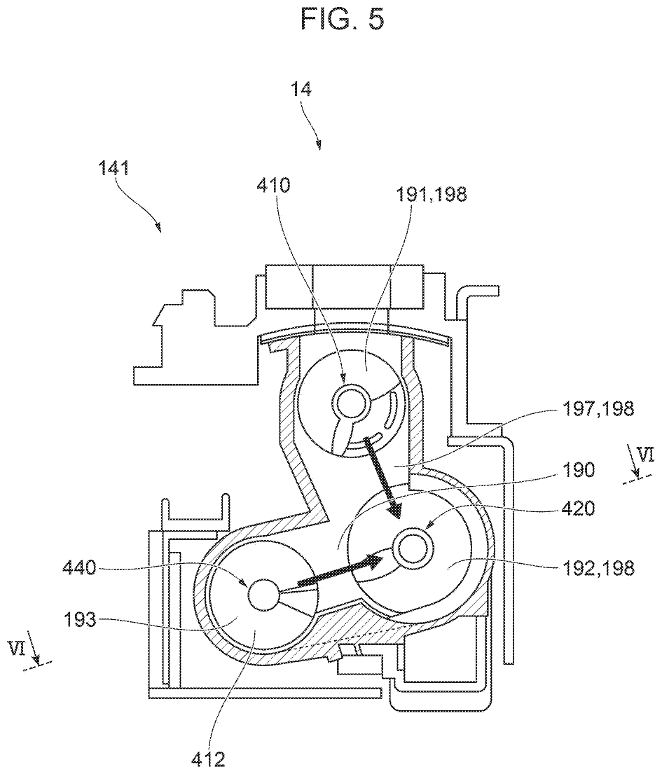

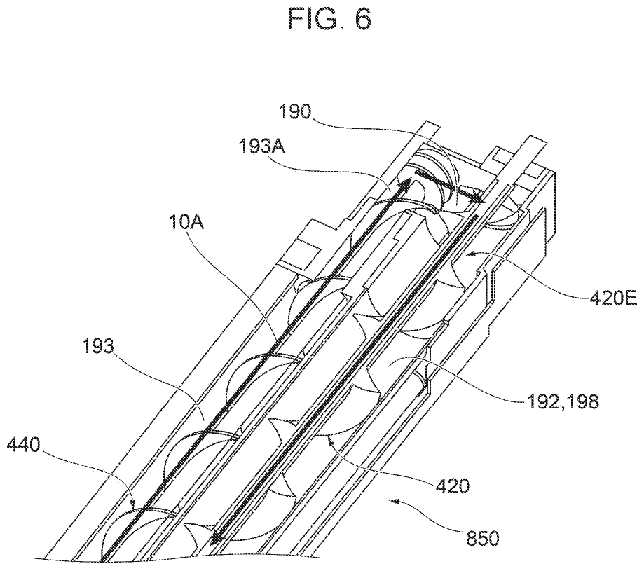

FIG. 5 is a sectional view of the developing device 14, taken along line V-V given in FIG. 2. FIG. 6 is a perspective view of a section of the developing device 14 that is taken along line VI-VI given in FIG. 2.

The section illustrated in FIG. 5 is taken at the first end 141 of the developing device 14.

In the present exemplary embodiment, as illustrated in FIG. 5, a downward movement path 197 is provided at the first end 141 of the developing device 14 and extends in the top-bottom direction.

As described above, the expression “to extend in the top-bottom direction” is not limited to a situation where the downward movement path 197 extends in the vertical direction and encompasses a situation where the downward movement path 197 is inclined relative to the vertical direction.

In the present exemplary embodiment, the developer transported along the first-direction movement path 191 passes through the downward movement path 197 toward the second-direction movement path 192.

In the present exemplary embodiment, the developer transported along the first-direction movement path 191 passes through the downward movement path 197 toward the second-direction movement path 192. Then, the developer is transported along the second-direction movement path 192 toward the second end 142 (see FIG. 2) of the developing device 14.

In the developing device 14 according to the present exemplary embodiment, the four paths of the first-direction movement path 191, the downward movement path 197, the second-direction movement path 192, and the upward movement path 196 (see FIG. 4) form a loop-shaped developer movement path 198.

In the present exemplary embodiment, the developer circulates along the loop-shaped developer movement path 198.

Furthermore, in the present exemplary embodiment, as illustrated in FIG. 5, a connecting path 190 extends laterally and thus connects the lower movement path 193 and the second-direction movement path 192 to each other.

In the present exemplary embodiment, the connecting path 190 serves as a path for the developer to move from the lower transporting member 440 to the second-direction transporting member 420.

The connecting path 190 is inclined obliquely upward. In other words, the connecting path 190 is inclined relative to both the horizontal direction and the vertical direction.

In the present exemplary embodiment, the developer transported by the lower transporting member 440 along the lower movement path 193 passes through the connecting path 190 toward the second-direction movement path 192.

In the present exemplary embodiment, the developer that has built up at the downstream end of the lower movement path 193 in the direction of movement of the developer is pushed by the developer gradually transported from the upstream side, thereby passing through the connecting path 190 toward the second-direction movement path 192.

As described above, the developing device 14 according to the present exemplary embodiment has the loop-shaped developer movement path 198, and the developer circulates along the loop-shaped developer movement path 198, whereby the developer is stirred.

In the present exemplary embodiment, while the developer that is being stirred is moving along the first-direction movement path 191 (see FIG. 3), some of the developer goes over the first movement stopper 450 and is supplied to the counter member 430, thereby adhering to the surface of the counter member 430.

The developer thus adhered to the surface of the counter member 430 moves with the rotation of the counter member 430 to the position in front of the photoconductor drum 11 and is supplied to the photoconductor drum 11.

Some developer adhered to the surface of the counter member 430 but failed to be supplied to the photoconductor drum 11 passes the position across from the magnetic pole 125 (see FIG. 3) serving as a pick-off pole and reaches a releasing area 296, where the developer is released from the counter member 430 and drops down.

The developer thus dropped down is received by the lower movement path 193 provided with the lower transporting member 440.

Referring to FIG. 6, the developer thus received by the lower movement path 193 moves along the lower movement path 193 and reaches an end, 193A, of the lower movement path 193 that is located on the downstream side in the direction of movement of the developer.

Then, the developer is pushed by the developer gradually transported from the upstream side and passes through the connecting path 190 into the second-direction movement path 192.

The developer thus reached the second-direction movement path 192 continues to move along the loop-shaped developer movement path 198.

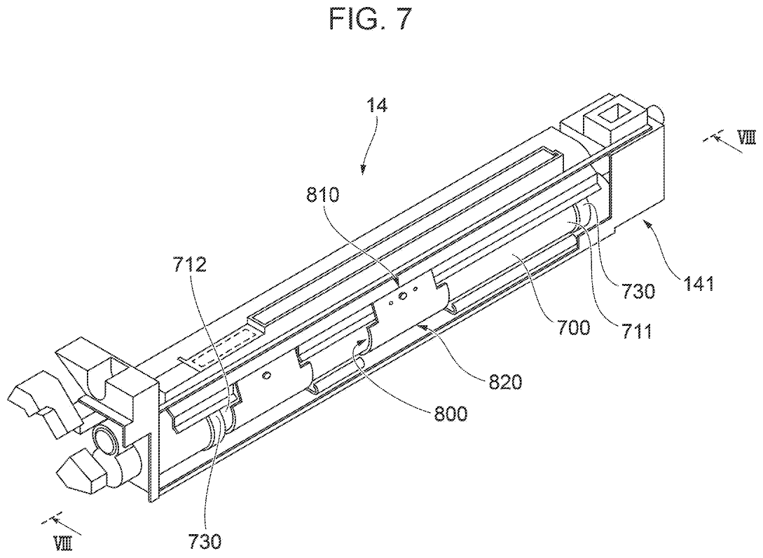

FIG. 7 is an upper perspective view of the developing device 14.

As illustrated in FIG. 7, the developing device 14 according to the present exemplary embodiment includes a pipe 700, which is an exemplary tubular member and extends in the longitudinal direction of the developing device 14. The pipe 700 is made of a metal material such as stainless steel.

In the present exemplary embodiment, the metal pipe 700 is utilized to promote heat radiation from the developing device 14.

The second-direction movement path 192 described above (see FIG. 3) is provided inside the pipe 700; that is, in the present exemplary embodiment, the developer is to be transported inside the pipe 700.

In the present exemplary embodiment, the second-direction transporting member 420 (see FIG. 3) is provided inside the pipe 700.

In the present exemplary embodiment, as described with reference to FIG. 3, the fourth movement stopper 454 that stops the movement of the developer between the first-direction movement path 191 and the second-direction movement path 192 is provided between the first-direction movement path 191 and the second-direction movement path 192. A part of the fourth movement stopper 454 is formed of a part of the pipe 700.

In the present exemplary embodiment, referring to FIG. 7, information on the developer that is present in the pipe 700 is acquired by a sensor (not illustrated in FIG. 7), which is supported by a sensor supporting member 800.

The sensor supporting member 800 is provided outside the pipe 700. The sensor supporting member 800 is made of a resin material. The sensor supporting member 800 has a first end 810 and a second end 820, which are at different positions in the peripheral direction of the pipe 700.

In the present exemplary embodiment, the pipe 700 is supported by a pipe supporting member 730. In the present exemplary embodiment, the pipe 700 is supported at a first end. 711, and a second end, 712, thereof in the axial direction by the pipe supporting member 730.

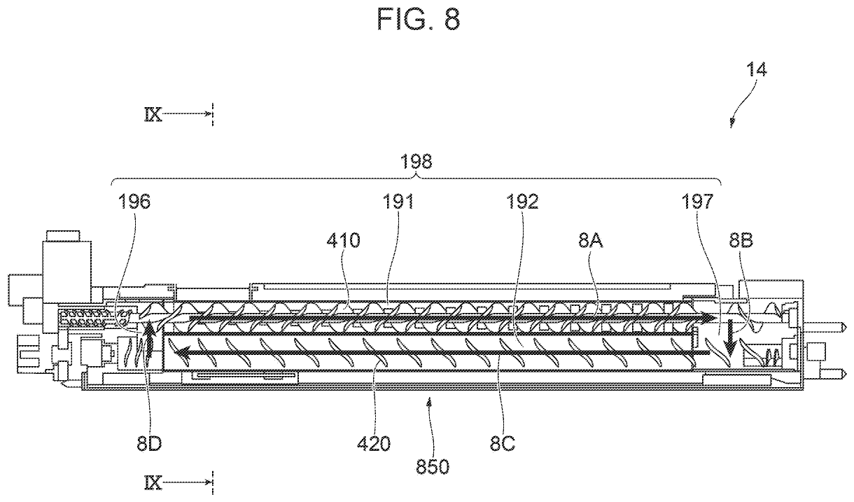

FIG. 8 is a sectional view of the developing device 14, taken along line VIII-VIII given in FIG. 7.

The section illustrated in FIG. 8 lies in a plane passing through both the second-direction movement path 192 and the first-direction movement path 191.

In the present exemplary embodiment, as illustrated in FIG. 8 and as described above, the first-direction movement path 191, the downward movement path 197, the second-direction movement path 192, and the upward movement path 196 form the loop-shaped developer movement path 198.

In the present exemplary embodiment, the developer is moved along the developer movement path 198 by a developer moving component configured to cause the developer to circulate.

In the present exemplary embodiment, the developer moving component configured to cause the developer to circulate includes the first-direction transporting member 410, the second-direction transporting member 420, the drive sources configured to rotate the transporting members 410 and 420, the first-direction movement path 191, the downward movement path 197, the second-direction movement path 192, the upward movement path 196, and other relevant elements.

The directions of movement of the developer in the first-direction movement path 191, in the downward movement path 197, in the second-direction movement path 192, and in the upward movement path 196 are represented by respective arrows 8A, 8B, 8C, and 8D.

In the first-direction movement path 191, as represented by arrow 8A in FIG. 8, the developer moves along the first-direction movement path 191 toward the downward movement path 197.

Then, as represented by arrow 8B, the developer moves along the downward movement path 197 toward the second-direction movement path 192.

Furthermore, as represented by arrow 8C, the developer moves along the second-direction movement path 192 toward the upward movement path 196.

Subsequently, as represented by arrow 8D, the developer moves along the upward movement path 196 toward the first-direction movement path 191.

In the present exemplary embodiment, the combination of the first-direction transporting member 410, the second-direction transporting member 420, the drive sources configured to rotate the transporting members 410 and 420, the first-direction movement path 191, the downward movement path 197, the second-direction movement path 192, the upward movement path 196, and other relevant elements is also regarded as a supplying mechanism, 850, configured to supply the developer to the counter member 430 (see FIG. 3).

The supplying mechanism 850, which is an exemplary supplying component, has a function of stirring the developer and is configured to supply the stirred developer to the counter member 430.

The supplying mechanism 850 stirs the developer by causing the developer to circulate and supplies the stirred developer to the counter member 430.

The supplying mechanism 850 sends the developer to the first-direction transporting member 410 and rotates the first-direction transporting member 410, thereby supplying the developer to the counter member 430 by using the first-direction transporting member 410.

As described above, the first-direction transporting member 410 includes the spiral projecting member 412 (see FIG. 3). In the area where the first-direction transporting member 410 is located, the developer that is pushed by the projecting member 412 moves toward the counter member 430.

In the area where the first-direction transporting member 410 is located, the developer moves toward the downstream side while being pushed toward the counter member 430 by the projecting member 412.

Thus, in the present exemplary embodiment, the developer transported by the first-direction transporting member 410 moves toward the counter member 430 and is supplied to the counter member 430. More specifically, the developer transported by the first-direction transporting member 410 goes over the first movement stopper 450 (see FIG. 3) and is supplied to the counter member 430.

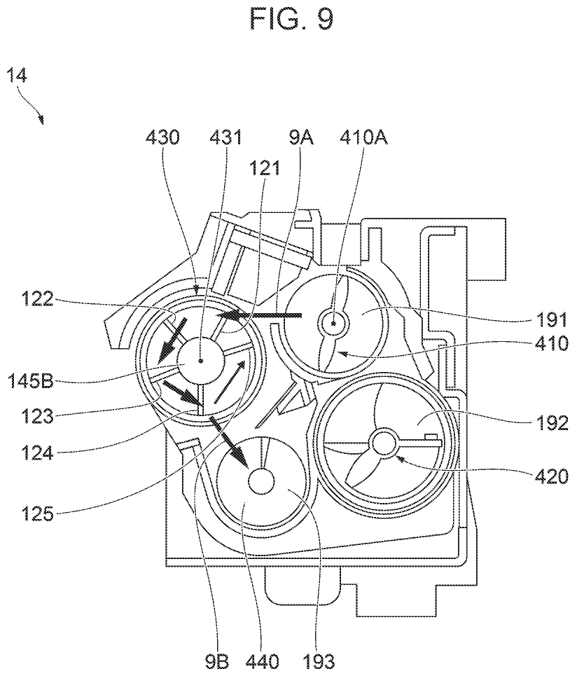

FIG. 9 is a sectional view of the developing device 14, taken along line IX-IX given in FIG. 8.

In the present exemplary embodiment, while the developer is moving along the first-direction movement path 191 toward the downstream side, the developer in the first-direction movement path 191 moves as represented by arrow 9A toward the counter member 430.

While the developer is moving along the first-direction movement path 191 toward the downstream side, the developer in the first-direction movement path 191 is pushed toward the counter member 430, whereby the developer is supplied to the counter member 430.

In the present exemplary embodiment, the developer thus supplied to the counter member 430 then moves toward the lower transporting member 440 as represented by arrow 9B. In other words, the developer failed to be transferred to the photoconductor drum 11 and remaining on the surface of the counter member 430 is released from the counter member 430 and drops into the lower transporting member 440.

In the area where the lower transporting member 440 is located, as represented by arrow 10A in FIG. 6, the lower transporting member 440 transports the developer to the connecting path 190.

The developer thus reached the connecting path 190 advances through the connecting path 190 to the second-direction movement path 192 provided in the supplying mechanism 850. Thus, the developer is supplied to a first end, 420E, of the second-direction transporting member 420.

The second-direction transporting member 420 is one of the constituents of the above-described supplying mechanism 850 having a function of stirring the developer.

In the present exemplary embodiment, the developer released from the counter member 430 is transported by the lower transporting member 440 to the supplying mechanism 850 having a function of stirring the developer.

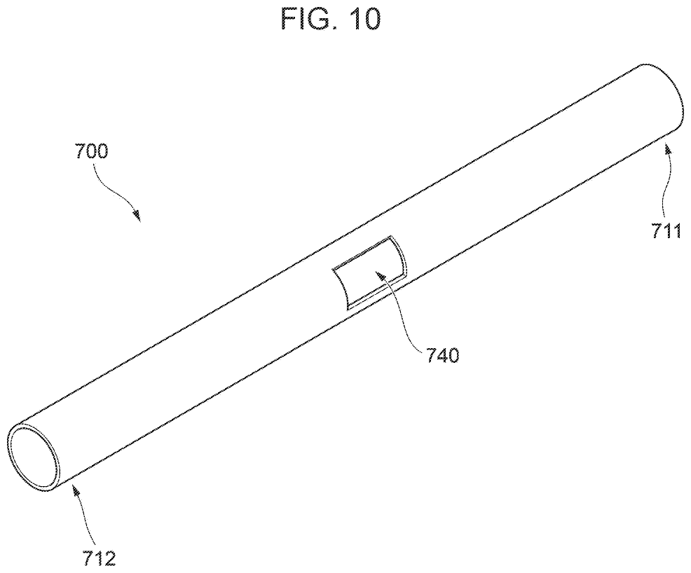

FIG. 10 is a perspective view of the pipe 700.

In the present exemplary embodiment, the pipe 700 as an exemplary tubular member has in a longitudinally central part thereof an opening 740, through which the inside and the outside of the pipe 700 communicate with each other. The opening 740 is elongated in the longitudinal direction of the pipe 700. The opening 740 has a rectangular shape. The longitudinal direction of the pipe 700 coincides with the axial direction of the pipe 700.

In the present exemplary embodiment, the sensor (not illustrated) configured to acquire information on the developer that is present in the pipe 700 and the sensor supporting member 800 (sec FIG. 7) supporting the sensor are provided at the opening 740.

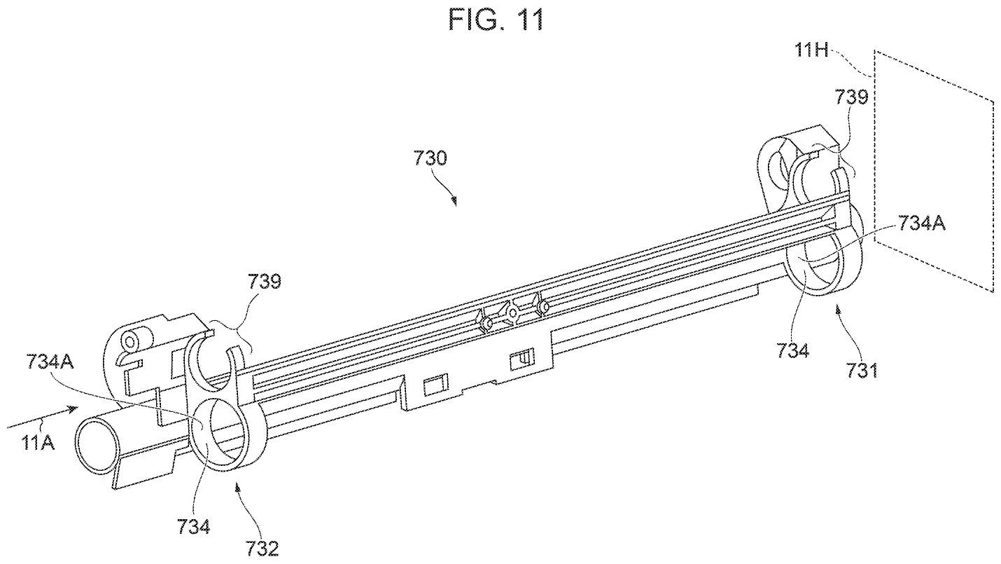

FIG. 11 is a perspective view of the pipe supporting member 730.

As an exemplary tube supporting member, the pipe supporting member 730 has a first end 731 and a second end 732, which are at different positions in the longitudinal direction of the pipe supporting member 730.

The first end 731 and the second end 732 are provided with respective end supports 734, which support the first end 711 (see FIG. 7) and the second end 712 of the pipe 700 (not illustrated in FIG. 11) in the longitudinal direction.

The end supports 734 include respective annular parts 734A. In the present exemplary embodiment, the pipe 700 extends through the annular parts 734A, thereby being supported by the pipe supporting member 730.

The shape of the part of each of the end supports 734 that is in contact with the pipe 700 is not limited to an annular shape as in the present exemplary embodiment and may be any other shape such as a U shape.

The end supports 734 further include respective projecting members 739, which project upward in FIG. 11.

The projecting members 739 each have a U shape as viewed in the direction of arrow 11A given in FIG. 11.

In the present exemplary embodiment, when the projecting members 739 are projected in the longitudinal direction of the pipe supporting member 730 onto a virtual plane 11H, which is orthogonal to the longitudinal direction, the projecting members 739 each have a U shape.

The pipe supporting member 730 also serves as part of a housing of the developing device 14 while being present inside the developing device 14. In the present exemplary embodiment, as illustrated in FIG. 7, the pipe supporting member 730 is partially exposed to the outside of the developing device 14.

The pipe supporting member 730 also supports other members in addition to the pipe 700.

For example, the pipe supporting member 730 supports the second-direction transporting member 420 (not illustrated in FIG. 7) with a bearing (not illustrated) interposed therebetween. The second-direction transporting member 420 extends through the U-shaped projecting members 739 (see FIG. 11).

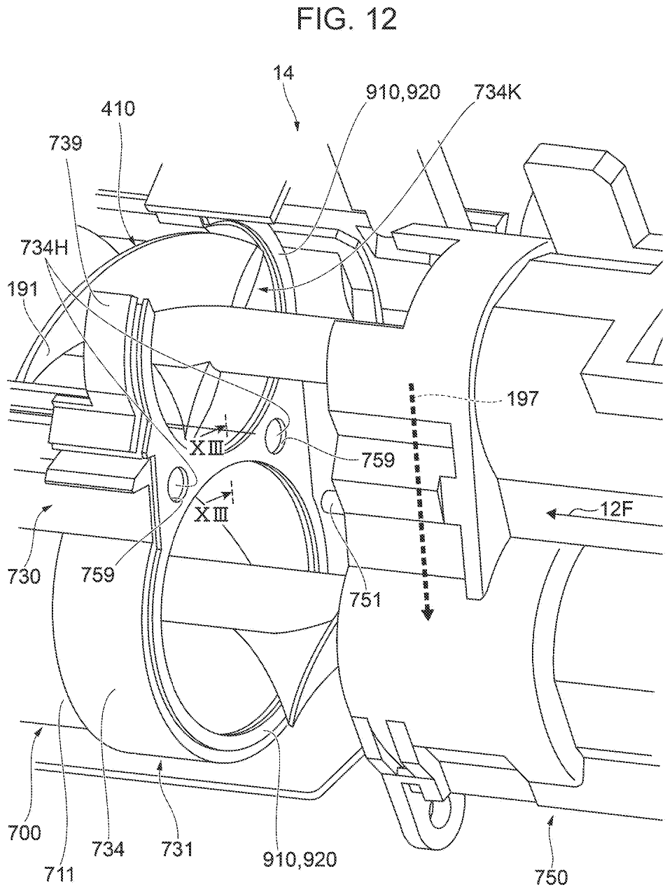

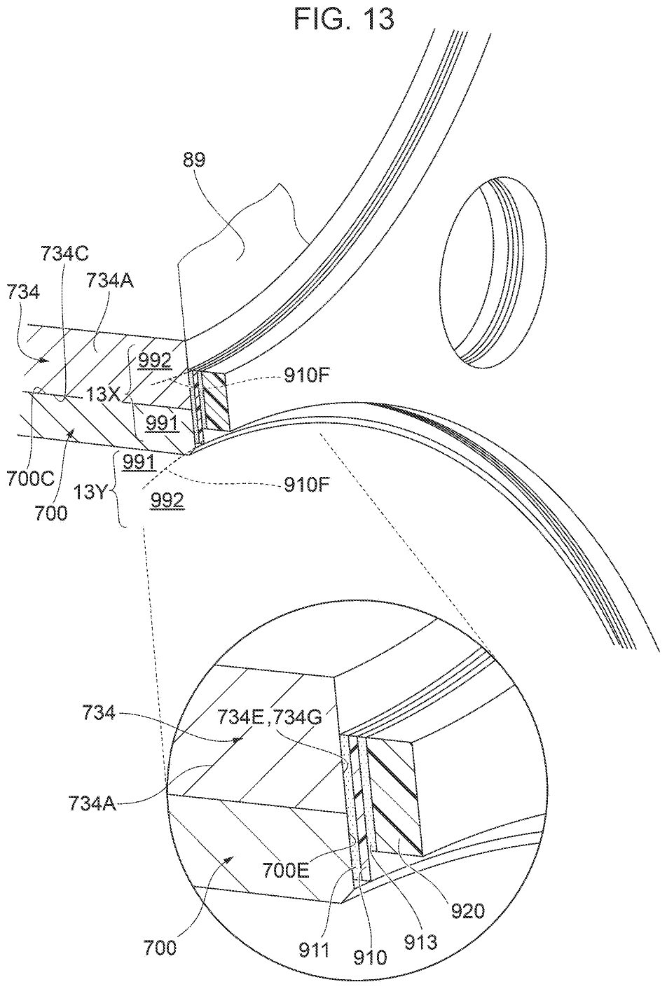

FIG. 12 is an enlargement of a part at the first end 731 of the pipe supporting member 730. FIG. 13 is a sectional view taken along line XIII-XIII given in FIG. 12.

In the present exemplary embodiment, as described above and as illustrated in FIG. 12.

the pipe supporting member 730 includes at the first end 731 thereof the end support 734 that supports the first end 711 of the pipe 700 in the longitudinal direction.

As illustrated in FIG. 11, the end support 734 includes the annular part 734A. In the present exemplary embodiment, the first end 711 of the pipe 700 extends through the annular part 734A of the end support 734, whereby the first end 711 of the pipe 700 is supported by the end support 734.

In the present exemplary embodiment, as illustrated in FIG. 13, a blocking member 910 is provided to block the developer from entering the gap between the outer peripheral surface, 700C, of the pipe 700 and the inner peripheral surface, 734C, of the annular part 734A of the end support 734.

The blocking member 910 extends over an end face, 700E, of the pipe 700 and an end face. 734E, of the annular part 734A.

The end support 734 has a flat face 734G. In the present exemplary embodiment, the end face 734E of the annular part 734A is the flat face 734G. The flat face 734G lies in an extension plane 89, which is obtained by extending the end face 700E of the pipe 700.

Herein, the term “extension plane 89” refers to a virtual plane obtained by extending the end face 700E of the pipe 700.

The end support 734 has the end face 734E. In the present exemplary embodiment, the end face 734E of the end support 734 lies in the extension plane 89 obtained by extending the end face 700E of the pipe 700.

In the present exemplary embodiment, the flat face 734G of the end support 734 also lies in the extension plane 89 obtained by extending the end face 700E of the pipe 700.

In the present exemplary embodiment, the blocking member 910 extends over the end face 700E of the pipe 700 and the end face 734E of the end support 734. Furthermore, the blocking member 910 extends over the end face 700E of the pipe 700 and the flat face 734G of the end support 734.

The blocking member 910 is bonded to both the end face 700E of the pipe 700 and the flat face 734G of the end support 734.

More specifically, in the present exemplary embodiment, double-sided adhesive tape 911 is provided between the blocking member 910 and both the end face 700E of the pipe 700 and the flat face 734G of the end support 734.

In the present exemplary embodiment, the double-sided adhesive tape 911 bonds the blocking member 910 to both the end face 700E and the flat face 734G.

The blocking member 910 is in the form of a plate extending along the end face 700E and the flat face 734G. The blocking member 910 is made of a resin material.

The resin material for the blocking member 910 is not particularly limited. The resin material may be, for example, polyethylene terephthalate (PET). Alternatively, the blocking member 910 may be made of, for example, a metal material.

The element that fixes the blocking member 910 to the end face 700E and the flat face 734G is not limited to the double-sided adhesive tape 911 and may be common adhesive.

In the present exemplary embodiment, the pipe 700 has a circular cylindrical shape, and the end face 700E of the pipe 700 correspondingly has an annular shape. In the present exemplary embodiment, the blocking member 910 is fixed to the annular end face 700E over the entire periphery of the end face 700E.

In the present exemplary embodiment, the flat face 734G of the end support 734 surrounds the annular end face 700E. That is, in the present exemplary embodiment, the flat face 734G also includes an annular part. In the present exemplary embodiment, the blocking member 910 is also fixed to the annular part of the flat face 734G over the entire periphery of the annular part.

In the present exemplary embodiment, as illustrated in FIG. 12, a pressing member 750 is pressed against the end support 734.

While the end support 734 and the pressing member 750 illustrated in FIG. 12 are spaced apart from each other, in the process of manufacturing the developing device 14, the pressing member 750 is fixed to the end support 734 in such a manner as to be pressed against the end support 734.

In the process of fixing the pressing member 750 to the end support 734, projecting members, 751, provided on the pressing member 750 are fitted into respective holes, 734H, provided in the end support 734.

Thus, the pressing member 750 is positioned relative to the end support 734.

As illustrated in FIG. 12, the blocking member 910 and an elastic member 920 (to be described below) each have through-holes 759, which receive the respective projecting members 751 of the pressing member 750.

In the present exemplary embodiment, the downward movement path 197 described above is provided inside the pressing member 750.

Specifically, in the present exemplary embodiment, the pressing member 750 has thereinside the downward movement path 197, and the downward movement path 197 serves as an exemplary developer passageway for the developer to move from the first-direction movement path 191 toward the pipe 700.

In other words, in the present exemplary embodiment, the pressing member 750 has thereinside the downward movement path 197 through which the circulating developer passes.

The direction of circulation of the developer is not limited to the direction illustrated in FIG. 8 and may be opposite to the direction illustrated in FIG. 8.

If the developer circulates in the opposite direction, the developer coming from the pipe 700 passes through the developer passageway provided inside the pressing member 750 (sec FIG. 12) toward the first-direction movement path 191.

In the present exemplary embodiment, as illustrated in FIG. 13, not only the blocking member 910 but also the elastic member 920 is provided.

In the present exemplary embodiment, when the pressing member 750 is fixed to the end support 734 (see FIG. 12), the elastic member 920 (see FIG. 13) is positioned between the end support 734 and the pressing member 750.

In the present exemplary embodiment, when the pressing member 750 is fixed to the end support 734, the elastic member 920 is nipped by the end support 734 and the pressing member 750 and is thus compressed.

The blocking member 910 is also nipped by the end support 734 and the pressing member 750.

The material for the elastic member 920 is not particularly limited. The material for the elastic member 920 may be, for example, a resin material such as polyurethane. As another example, the elastic member 920 may be made of rubber or the like. In the present exemplary embodiment, the elastic member 920 is also in the form of a plate.

In the present exemplary embodiment, as illustrated in FIG. 13, the blocking member 910 supports the elastic member 920.

In the present exemplary embodiment, double-sided adhesive tape 913 is provided between the blocking member 910 and the elastic member 920, whereby the elastic member 920 is fixed to the blocking member 910.

In the present exemplary embodiment, the area of the blocking member 910 in front view is greater than the area of the elastic member 920 in front view.

In the present exemplary embodiment, the area of the blocking member 910 as viewed in a direction represented by arrow 12F given in FIG. 12 is greater than the area of the elastic member 920 as viewed in the direction of arrow 12F given in FIG. 12.

In the present exemplary embodiment, in the front view of the blocking member 910, the elastic member 920 does not project outward relative to the peripheral edge of the blocking member 910 (see FIG. 13).

As illustrated in FIG. 13, the blocking member 910 in the form of a plate has edges 910F.

In the present exemplary embodiment, a present area 991 and an absent area 992 are defined on the opposite sides of each of the edges 910F, as denoted by 13X and 13Y.

The present area 991 refers to an area where the blocking member 910 is present. The absent area 992 refers to an area where the blocking member 910 is absent.

In the present exemplary embodiment, in the front view of the blocking member 910 and the elastic member 920, the clastic member 920 is present within the two present areas 991 where the blocking member 910 is present, whereas the elastic member 920 is absent in both of the two absent areas 992 where the blocking member 910 is absent.

If the elastic member 920 is present in at least one of the absent areas 992, that part of the elastic member 920 may be mixed into the developer.

If the elastic member 920 is present in at least one of the absent areas 992, a part of the clastic member 920 that is present in the absent area 992 is not nipped by the blocking member 910 and the pressing member 750 (see FIG. 12) and is therefore free from restraint.

In such a case, the part of the elastic member 920 that is present in the absent area 992 is more likely to be chipped off than the other part of the elastic member 920, and such a chipped part of the elastic member 920 may be mixed into the developer.

In contrast, in the present exemplary embodiment, the elastic member 920 does not project outward relative to the edges 910F of the blocking member 910 and is absent in the absent areas 992.

In the present exemplary embodiment, to place the blocking member 910 and the elastic member 920 into the developing device 14, the elastic member 920 is first fixed to the blocking member 910. Then, the blocking member 910 with the elastic member 920 fixed thereto is fixed to the end face 700E of the pipe 700 and the flat face 734G of the end support 734.

In the present exemplary embodiment, the blocking member 910 has a higher rigidity than the elastic member 920.

In the above-mentioned case where only the blocking member 910 is fixed to the end face 700E and the flat face 734G before the elastic member 920 is fixed to the blocking member 910, the fixing of the elastic member 920 tends to be troublesome because such an elastic member 920 is easy to deform.

If the blocking member 910 has a lower rigidity than the elastic member 920, the shape of the blocking member 910 with the elastic member 920 fixed thereto is less likely to be maintained.

Accordingly, the blocking member 910 with the elastic member 920 fixed thereto is difficult to fix to the end face 700E and the flat face 743G.

In the present exemplary embodiment, as illustrated in FIG. 12, the end support 734 has an opening 734K, through which the developer advancing toward the downward movement path 197 provided inside the pressing member 750 passes.

In the present exemplary embodiment, as illustrated in FIG. 12, the blocking member 910 and the elastic member 920 each reach the peripheral edge of the opening 734K of the end support 734.

The peripheral edge of the opening 734K of the end support 734 is formed as the U-shaped projecting member 739 described above.

In the present exemplary embodiment, the edge of the opening 734K is defined by the U-shaped projecting member 739, and the blocking member 910 and the elastic member 920 are fixed to the projecting member 739 as well.

If another blocking member 910 and another elastic member 920 to be fixed to the peripheral edge of the opening 734K are prepared separately from the blocking member 910 and the elastic member 920 fixed to the annular end face 700E (see FIG. 13) described above, not only the number of relevant components increases but also the labor in the fixing of the blocking member 910 and the elastic member 920 increases.

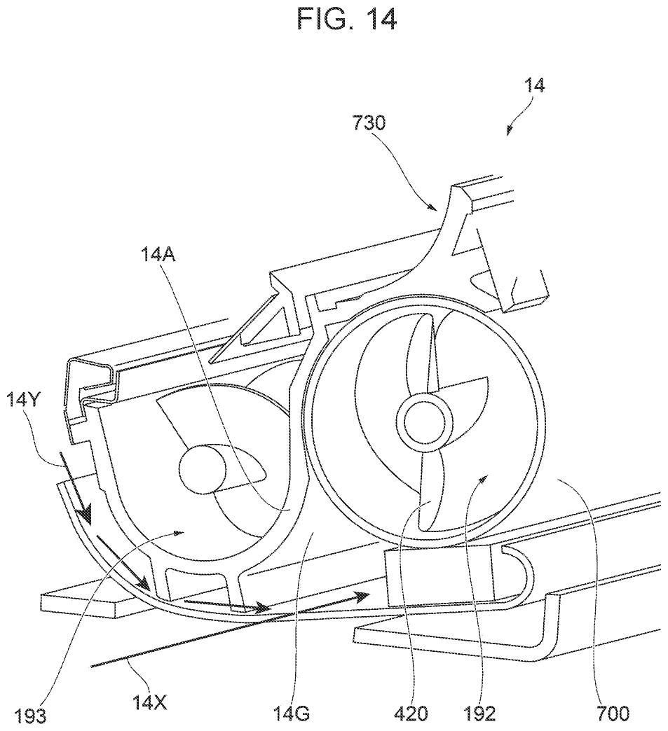

FIG. 14 is a perspective view of a section of a lower part of the developing device 14 that is taken in a longitudinally central part of the developing device 14.

In the developing device 14 according to the present exemplary embodiment, a gap 14G is provided between the pipe 700 and a part, 14A, of the pipe supporting member 730. The gap 14G extends in the longitudinal direction of the developing device 14. In the present exemplary embodiment, air flowing in the image forming apparatus 100 (see FIG. 1) passes through the gap 14G, as represented by arrow 14X. Thus, the pipe 700 is cooled.

Furthermore, in the present exemplary embodiment, a passageway is provided for air coming from an area near the photoconductor drum 11 (not illustrated in FIG. 14) to flow through as represented by arrow 14Y in FIG. 14. In the present exemplary embodiment, the air having flowed through the passageway flows into the gap 14G.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A developing device comprising:
a tubular member through which developer is to be transported;
an end support that supports an end of the tubular member; and
a blocking member that extends over an end face of the tubular member and the end support and that blocks the developer from entering a gap between an outer peripheral surface of the tubular member and the end support.
   (((2)))

The developing device according to (((1))),
wherein the end support has a flat face lying in an extension plane obtained by extending the end face, and
wherein the blocking member extends over the end face and the flat face.
   (((3)))

The developing device according to (((2))),
wherein the blocking member is bonded to both the end face and the flat face.
   (((4)))

The developing device according to (((2))) or (((3))),
wherein the blocking member is in a form of a plate extending along the end face and the flat face.
   (((5)))

The developing device according to any one of (((1))) to (((4))), further comprising:
a pressing member that is pressed against the end support and has a developer passageway through which the developer coming from the tubular member passes or the developer advancing toward the tubular member passes; and
an elastic member that is provided between the end support and the pressing member,
wherein the blocking member supports the elastic member.
   (((6))

The developing device according to (((5))),
wherein the blocking member has a higher rigidity than the elastic member.
   (((7)))

The developing device according to (((5))),
wherein the end support has an opening through which the developer coming from the developer passageway provided in the pressing member passes, or an opening through which the developer advancing toward the developer passageway passes; and
wherein the blocking member reaches a peripheral edge of the opening of the end support.
   (((8)))

The developing device according to (((7))),
wherein the elastic member reaches the peripheral edge of the opening of the end support.
   (((9)))

An image forming apparatus comprising:
an image carrier; and
a developing device configured to form an image on the image carrier by performing development on the image carrier,
wherein the developing device includes the developing device according to any one of (((1))) to (((8))).

What is claimed is:

1. A developing device comprising:
a tubular member through which developer is to be transported;
an end support that supports an end of the tubular member; and
a blocking member that extends over an end face of the tubular member and the end support and that blocks the developer from entering a gap between an outer peripheral surface of the tubular member and the end support.

2. The developing device according to claim 1,
wherein the end support has a flat face lying in an extension plane obtained by extending the end face, and
wherein the blocking member extends over the end face and the flat face.

3. The developing device according to claim 2,
wherein the blocking member is bonded to both the end face and the flat face.

4. The developing device according to claim 2,
wherein the blocking member is in a form of a plate extending along the end face and the flat face.

5. The developing device according to claim 1, further comprising:
a pressing member that is pressed against the end support and has a developer passageway through which the developer coming from the tubular member passes or the developer advancing toward the tubular member passes; and
an elastic member that is provided between the end support and the pressing member,
wherein the blocking member supports the elastic member.

6. The developing device according to claim 5,
wherein the blocking member has a higher rigidity than the elastic member.

7. The developing device according to claim 5,
wherein the end support has an opening through which the developer coming from the developer passageway provided in the pressing member passes, or an opening through which the developer advancing toward the developer passageway passes; and
wherein the blocking member reaches a peripheral edge of the opening of the end support.

8. The developing device according to claim 7,
wherein the elastic member reaches the peripheral edge of the opening of the end support.

9. An image forming apparatus comprising:
an image carrier; and
a developing device configured to form an image on the image carrier by performing development on the image carrier,
wherein the developing device includes the developing device according to claim 1.

10. An image forming apparatus comprising:
an image carrier; and
a developing device configured to form an image on the image carrier by performing development on the image carrier,
wherein the developing device includes the developing device according to claim 2.

11. An image forming apparatus comprising:
an image carrier; and
a developing device configured to form an image on the image carrier by performing development on the image carrier,
wherein the developing device includes the developing device according to claim 3.

12. An image forming apparatus comprising:
an image carrier; and
a developing device configured to form an image on the image carrier by performing development on the image carrier,
wherein the developing device includes the developing device according to claim 4.

13. An image forming apparatus comprising:
an image carrier; and
a developing device configured to form an image on the image carrier by performing development on the image carrier,
wherein the developing device includes the developing device according to claim 5.

14. An image forming apparatus comprising:
an image carrier; and
a developing device configured to form an image on the image carrier by performing development on the image carrier,
wherein the developing device includes the developing device according to claim 6.

15. An image forming apparatus comprising:
an image carrier; and
a developing device configured to form an image on the image carrier by performing development on the image carrier,
wherein the developing device includes the developing device according to claim 7.

16. An image forming apparatus comprising:
an image carrier; and
a developing device configured to form an image on the image carrier by performing development on the image carrier,
wherein the developing device includes the developing device according to claim 8.

17. An image forming apparatus comprising:
an image carrier; and
a developing device configured to form an image on the image carrier by performing development on the image carrier,
wherein the developing device includes the developing device according to claim 9.

18. A developing device comprising:
tubular means for allowing developer to be transported through the tubular means;
end supporting means for supporting an end of the tubular means; and
blocking means for blocking the developer from entering a gap between an outer peripheral surface of the tubular means and the end supporting means, the blocking means extending over an end face of the tubular means and the end supporting means.
